(19) United States
(12) Patent Application Publication
(10) Pub. No.: US 2011/0256512 A1
(43) Pub. Date: Oct. 20, 2011

(54) METHODS AND APPARATUS FOR MODULATING VARIABLE GRAVITIES AND LAUNCHING VEHICLES

(76) Inventors: Jerry J. Huang, San Jose, CA (US); Li Jieh Huang, San Jose, CA (US)

(21) Appl. No.: 13/084,585

(22) Filed: Apr. 12, 2011

Related U.S. Application Data
(60) Provisional application No. 61/326,221, filed on Apr. 20, 2010.

(51) Int. Cl. G09B 9/00

(52) U.S. Cl. 434/34

(57) ABSTRACT

A system, method, and apparatus are described for providing a reduced or modulated gravity environment in a land-based facility. The system includes the evaluation of terrain and man-made structures to support a vertical vehicle guide, the construction of a vehicle guide, the provision of a vehicle and a control system adapted to control a motion of the vehicle up and down along the vehicle guide with a specific velocity profile so as to produce a selected modulated gravity environment. The same apparatus can also be used as a vehicle launching method.

### CROSS-REFERENCE TO RELATED APPLICATIONS

The present application claims the benefit of U.S. provisional patent application No. 61/326,221 filed on Apr. 20, 2010 by the present applicants. The disclosure of which is hereby incorporated by reference into this application.

### FIELD OF INVENTION

This invention relates to selecting terrain features and/or man-made structures for establishing controlled effective gravitational environments and launching vehicles.

### BACKGROUND AND PRIOR ART

The following is a list of some prior art and publication that is relevant:

### US Patent and Trademark Office:

| Patent Number | Issue Date | Patentee |
|---|---|---|
| 6,743,019 | Jun. 1, 2004 | Ransom, et al. |
| 6,311,926 | Nov. 6, 2001 | Powell, et al. |
| 7,830,047 | Nov. 9, 2010 | Putman; Phil, et al |
| 5,971,319 | Oct. 26, 1999 | Lichtenberg, et al |
| Pub or App No. | Date | Applicant |
| 20080078875 | Apr. 3, 2008 | Diamandis, et al. |
| US12/924,322 | Oct. 22, 2010 | Huang, et al. |

### Foreign Patent Document:

| Publication | Publication | |
|---|---|---|
| Number | Date | Applicants |
| DE 201 14 763 U 1 | Jan. 30, 2003 | HUSS MASCHFAB GMBH & CO |
| | | [DE] |
| CN 101482455 A | Jul. 15, 2009 | Wang Peiming, et al. |

### Non-Patent Literature

### General Atomics Electromagnetics Division Overview

Since the early stage of the space program, NASA had conducted zero and reduced gravity experiments in aircraft by means of a parabolic flight for training Mercury astronauts. The quality of the microgravity is up to the skill of the pilots, weather and the aircraft. Longer duration microgravity experiments have been conducted in orbital and extra-orbital systems. It is known that various materials, technical processes, and biological systems exhibit different behavior in microgravity as compared with typical Earth gravity. The entertainment value of experiencing a substantially low gravity environment has been known for some time, as companies are running the business of zero gravity parabolic flights for paying customers for years. Commercial space flight pioneers are planning sub-orbital flights and accepting reservations. These flights exert high stresses on airframe structural members, and provide the desired reduced gravity for short durations. Airborne low gravity environments are understood to be expensive and space borne environments are extremely expensive. These and other factors limit the use and popularity of existing systems.

Present day zero G drop towers in amusement parks or research facilities are limited by the vertical heights, they can produce only few seconds of zero G duration. It is far from enough time for people to experience the sensation of being weightless. Trying to achieve longer fall duration with a dedicated higher tower or the like is impractical because: 1. The structure of the dedicated tower would be difficult over 150 meters. 2. The air drag and friction forces would prevent the drop from the ideal free falling speed required, and 3. Most importantly, they can only use the principle of the free fall to produce zero gravity. These are the impeding factors that the inventors set out to overcome.

German patent number DE 201 14 763 U 1, title: Roller Coaster has a Carriage with Parabolic Section so that the Rider feels no Effects of Gravity in the Cabin. The description does not mention the height of the parabolic track drop. The practical weightless time can not achieve much more than the existing zero G drop towers for the same reason. A flaw in the constructive reduction to practice with this concept is that the wheels of the carriage will lose traction completely during zero gravity, and separate from the track with a high speed. Chinese patent number CN 101482455, title: Following type zero-gravity simulation test method. The method is meant to test mechanical parts to be deployed in space, for example, solar panel arms of artificial satellites. It is only a simulation of zero gravity by applying an equal amount of force to cancel out the weight. The subject under test itself is still experiencing gravity. A better test method would be creating a real weightlessness environment cheaply in a ground facility. The drop tower in Bremen, Germany is supposed to do that, but it is limited by the size of the small capsule and the height of 140 meters.

Moreover, reduced gravities, that is between 0 G and the Earth's gravity, simulation is needed for testing and evaluating the operation of equipment and processes that are to operate on the surface of the Moon or Mars. It is extremely expensive and rather problematic to simulate the reduced gravities for more than eight seconds using drop methods. For example, an atmospheric fall capsule can be dropped from an aircraft at a high altitude to achieve Martian gravity for 40 seconds. It is theoretically possible, but not known to exist yet. Extremely complicated braking and balancing mechanism are needed to keep the capsule fall toward the Earth with an acceleration of ⅝ of Earth's gravitational acceleration, so as to experience a residual weight of ⅜ g inside the capsule, as on Mars. Manned drop capsules will be even more difficult presumably due to the safety concerns. A workable solution is to use an aircraft flying along a parabolic flight path to simulate low gravities similar to zero G flights.

U.S. Pat. No. 6,743,019 is to compensate the unwanted varying slope during the parabolic flight to simulate reduced gravities. The varying slope inside the cabin is caused by the changing attitude of the aircraft along the parabolic flight path. The invention deploys a sophisticated mount for a spherical test chamber inside the fuselage to balance the undesirable slope effects. That will reduce the available room to a small fraction of the available space.

Furthermore, since the early stage of the missile and space age, vehicles have been launched into a target or outer space in orbit around the earth using rocket propulsion. The majority of weight of the spacecraft is found in the main rocket engines and the required fuel and oxidizer. Therefore, there is little available weight for the remaining spacecraft itself and payloads to reach earth's orbit. Spacecraft may either be manned or unmanned, and in either case may be used for placing payloads, such as satellites in earth's orbit. The high cost results from the inherent limitations of rockets, with their payload fraction being only about 1%, and they are complex, dangerous and very expensive for both expendable and reusable versions, such as the shuttle. An alternative way of launching spacecrafts into a low earth orbit (LEO) or sub-orbit is using a mother ship carrying the rocket to a high altitude in order to save weight and fuel. Virgin Galactic uses White Knight II as the mother ship to carry Space Ship II as the rocket to an Earth's sub-orbit.

U.S. Pat. No. 6,311,926 space tram is a new way of launching a spacecraft into orbit around the earth by magnetically suspending a sky tube having an inlet on earth and an outlet at a high altitude. The sky tube is evacuated, and the spacecraft is propelled through to achieve escape velocity for reaching outer space. The structure of the suspension is prone to damages done by the weather alone. If the inside of the sky tube is to be evacuated, the tube structure will be prohibitively expensive to withstand the atmospheric pressure. All the materials needed for the construction of such sky tube and supports must be manufactured and assembled. A permanent tube will solve these problems in order to achieve a more reliable and economical means of launching spacecrafts.

### SUMMARY

In view of all the above disadvantages, the disclosure is to provide land-based methods and apparatuses to improve quality and reduce the cost of the existing means of producing zero, variable gravities and launch methods. A tourists' attraction business will be able to run the weightlessness operation with an admission ticket price of an amusement park. One of the disclosed embodiments is to select terrain features and utilize the structural integrity of the terrain for both modulating variable gravities and launching vehicles. The cost of launching spacecraft into orbits can also be greatly reduced with a variant application of the apparatus.

This specification describes a land-based vehicle guide system for modulating gravities or launching vehicles. By selecting terrain features and utilizing buildings as the structure, a macroscopic vertical distance will be safe. The methods use both the upward and downward motion of the vehicle to double the zero gravity or variable gravity duration than a drop method. The principle behind is to use both inertia and free fall to produce zero gravity. Drop method uses only free fall to produce zero gravity. With the advent of the high-powered linear electromagnetic motors, it is practical to drive delicate payloads vertically up to high speeds and utilize the inertia to modulate variable gravities. One special application of the same apparatus can be used to launch vehicles, gaining an enough initial speed at the top of the vehicle guide in order to reach Earth's orbits or other destinations with a smaller rocket. Few embodiments of the basic version are to reduce operating and construction costs by effective distribution of power.

U.S. Pat. No. 7,830,047 Linear Motor Geometry for Use with Persistent Current Magnets and other publications, for example, General Atomics Electromagnetics Project Overview in the field of electromagnetic launch apparatuses showed the rapid advances in recent years. The information also revealed the suppliers of these latest defense technologies. The present disclosure is an alternative and commercial use of these latest technologies.

### BRIEF DESCRIPTION OF THE DRAWINGS

FIG. 1 shows the vehicle, part of the vehicle guide and control block diagram.

FIG. 2A shows a selection of the vertical height for the operation of the vehicle, injection point and recovery point.

FIG. 2B shows a different use of the system for vehicle launch.

FIG. 3 shows another selection of the vertical height for the operation of the vehicle, injection point and recovery point.

FIG. 4 shows multiple vehicle guides and vehicles working in concert.

FIG. 5A shows a single vehicle guide loop to operate multiple vehicles.

FIG. 5B shows different parking mechanisms for the single vehicle guide loop.

FIG. 6 shows the functioning block diagram for the vehicle system control.

Drawings - Reference Numerals

| | |
|---|---|
| 100 vehicle and vehicle guide system | 102 vehicle |
| 104, 106, 108 vehicle cabin spaces | 105, 107, 109 vehicle entrances |
| 110, 112 vehicle guides | 116 support and release mechanism |
| 120 vehicle control subsystem | |
| 122 vehicle guide control subsystem | 124 communication subsystem |
| 126 system controller | 130 user interface subsystem |
| 200 vehicle guide and terrain | 202 terrain profile |
| structure | |
| 204 height of vehicle guide | 206 top |
| 208 bottom | 210 injection point |
| 212 acceleration distance and | 214 free ascent distance and |
| direction | direction |
| 220 recovery point | 222 free fall distance and direction |
| 224 braking distance and direction | 230 vehicle |
| 240 transportation tunnel | |
| 260 vehicle ready for launch | 262 vehicle accelerating |
| 264 vehicle launched | |
| 310 building structure | 312 building height |
| 314 ground level | 316 well structure |
| 318 depth of well | 320 height of vehicle guide |
| 330 injection point | 332 acceleration distance and |
| | direction |
| 334 free ascent distance and direction | 340 recovery point |
| 342 free fall distance and direction | 344 braking distance and direction |
| 350 vehicle | |
| 400 multiple guide set | |
| 410 guide one | 412 vehicle one |
| 420 guide two | 422 vehicle two |
| 430 guide three | 440 guide four |
| 450 guide five | 460 guide six |
| 470 recovery point | 472 injection point |
| 480 top of guide | 482 bottom of guide |
| 500 guide loop one | 502 guide loop two |
| 510 top | 512 bottom |
| 520, 522, 524 curved guide sections | 526 vehicle moving direction |
| 530 top portion | 532 bottom portion |
| 540 top portion | 550 horizontal parking mechanism |
| 560 vertical parking mechanism | 570 extended guide track |
| 600 system control | 602 scheduling/dispatch control |
| 604 vehicle control | 610 power distribution control |
| 612 oversight subsystem | 620 motion control |
| 622 parking control | 624 cabin environment control |
| 630 propulsion control | 632 braking control |
| 640 mechanical braking control | 642 regenerative braking control |

### DETAILED DESCRIPTION

### First and Basic Embodiment

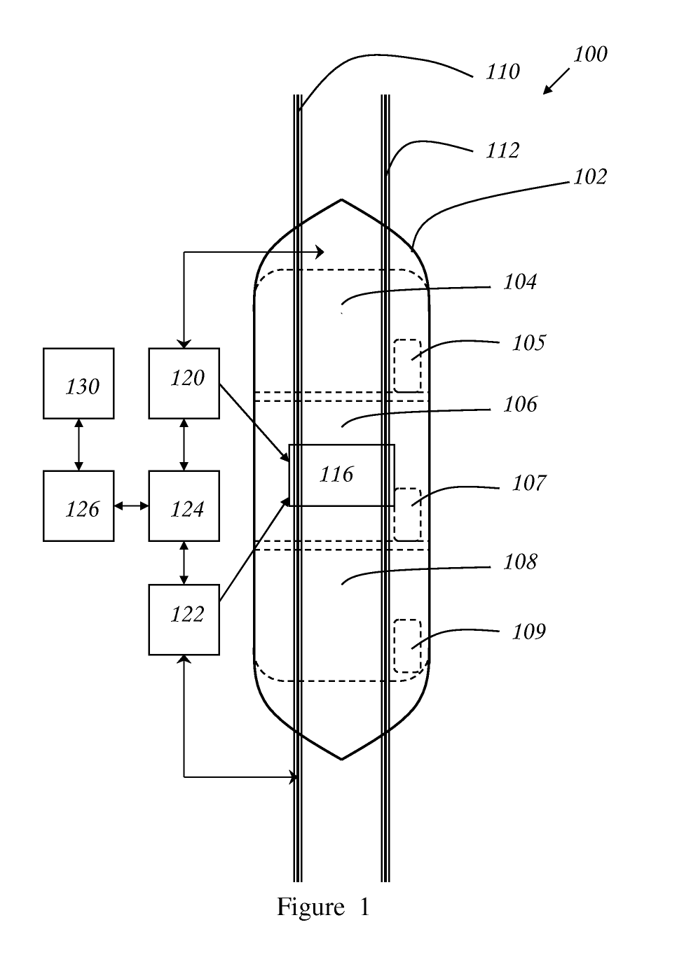

FIG. 1 shows a vehicle 102 and a portion of the vehicle guide system 100. As illustrated, the system 100 includes a vehicle 102 having cabin spaces 104, 106, and 108 adapted to be movably coupled to a substantially vertical vehicle guide 110 or a plurality of guides, 110, 112. One of skill in the art will readily appreciate that guides 110, 112 are intended to represent a guiding mechanism appropriate to the demands of a particular application. Accordingly, as discussed in additional detail below, the guiding mechanism may include any of a variety of devices such as linear electromagnetic propulsion devices, speed sensing devices, rails of various materials, and such other support and release mechanism 116 for vehicles as currently exist or may be developed. The vehicle guide, 110 (and 112) provides propulsion for the vehicle. The vehicle's cabin space can be multi-leveled with multiple entrances 105, 107, 109 as illustrated. The vehicle has no propulsion means by itself. It is a payload carrier. The vehicle can be released or detached from the vehicle guide for different applications.

According to certain aspects and embodiments of the invention, the vehicle and guide system 100 includes a vehicle control subsystem 120, at least a portion of which is disposed within the vehicle 102, and a vehicle guide control subsystem 122. The vehicle control subsystem 120 and the vehicle guide control subsystem 122 control the velocity of the vehicle and support/release mechanism 116 of the vehicle. The release mechanism 116 is to detach the vehicle during the operation mode of launching. The vehicle control subsystem 120 and the vehicle guide control subsystem 122 are coupled through a communications subsystem 124 to a system controller 126.

In certain embodiments, the system controller 126 is coupled to a user interface subsystem 130. According to certain aspects of the invention, the user interface subsystem 130 allows the communication of status and supervisory information between the system as a whole and certain supervisory personnel. The various subsystems allow controlled operation of the vehicle 102 within the guiding system to produce an inertial environment with modulated effective gravity over certain time intervals.

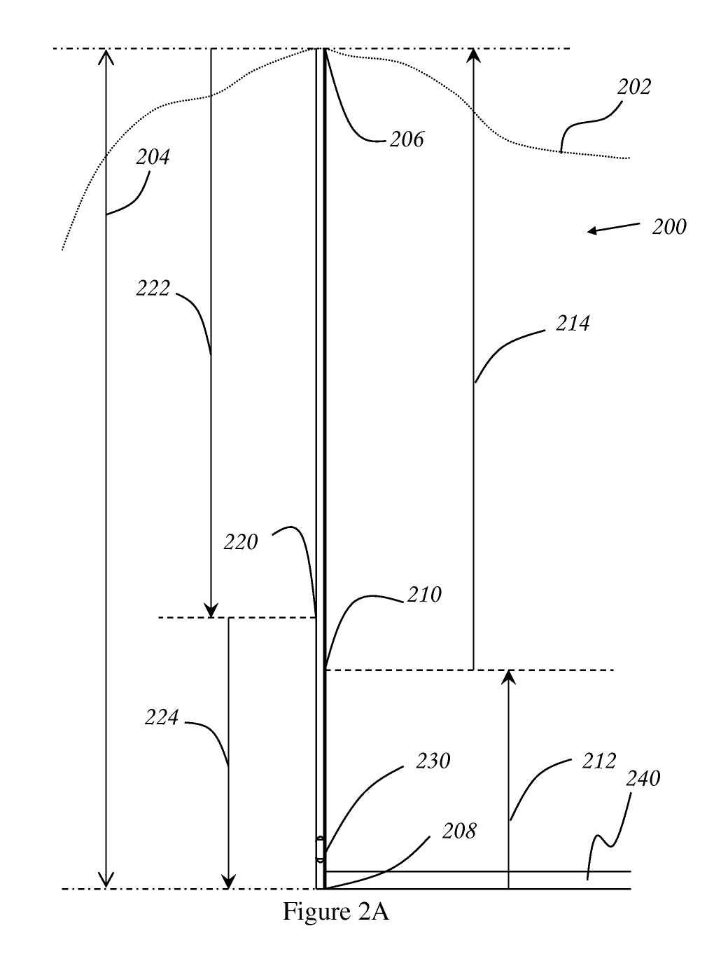

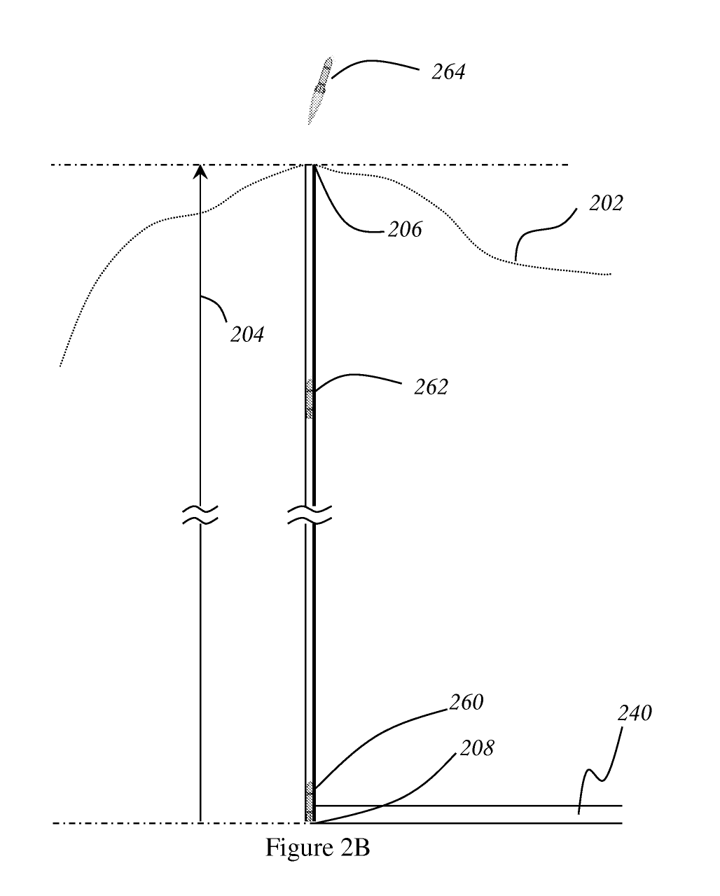

FIG. 2A shows the total height 204 of the vehicle guide system 200 according to certain aspects of the invention. The illustrated embodiment shows, in cross-section, a terrain profile 202 selected for having a macroscopic vertical distance 204 for the vehicle guide. The deepest vertical shaft mine today is over 3,500 m or more than 2 miles down. A similar well structure for the vehicle guide will be structurally sound. The top of the guide is 206, the bottom of the guide is 208.

Injection point 210 is the point at which the vehicle's upward acceleration ends. From this point on, the vehicle and everything inside will be still going up by inertia, but slowing down at the same rate of g. Thus, weightlessness is experienced inside the vehicle 230. 212 is the distance and direction for accelerating the vehicle 230. 214 is the distance and direction for free ascent by inertia of the vehicle 230.

Recovery point 220 is the point at which free fall ends. From this point on, the vehicle is braking and slowing down to a stop at the bottom 208. In the present invention, an electromagnetic braking system is used to generate power, similar to the principle of a hybrid car. The vehicle is converting its kinetic energy into electrical energy. 222 is the distance and direction of the free fall, and 224 is the distance and direction for slowing down of the vehicle 230.

According to the principle of the embodiments, injection point 210 and recovery point 220 are not fixed points. The locations of these points are programmable, depending on how the vehicle 230 is to be operated. The vehicle can be accelerated up, and slowed down in a predetermined fashion. In the extreme case of being used as a vehicle launching system, the injection point 210 will be coincided with the top 206 of the vehicle guide, and there will be no recovery point. Ideally, there is no need for any propulsion for the vehicle during the inertial or free ascent after the injection point. There is no need for propulsion either during free fall before the recovery point. Nevertheless, regulated low power propulsion is still necessary in order to compensate the air drags and other friction forces that always slow down the motion of the vehicles.

The vehicle guide utilizes the structural integrity of the terrain 202 to maximize the vertical distance for the vehicle to travel. The location of the underground site should be near a railway tunnel 240 for transportation. The advantage of this embodiment is to maximize the weightlessness duration for zero G operation, and longer distance for accelerating the vehicle during vehicle launch.

FIG. 2B shows a different operation mode of the vehicle guide as a vehicle launching facility. 260 is a vehicle readied to be launched. 262 is the vehicle being accelerated along the vehicle guide by the power from the vehicle guide. The launched vehicle 264 has gained an initial velocity, starts it own propulsion and adjusts its optimized angle toward the target after launching.

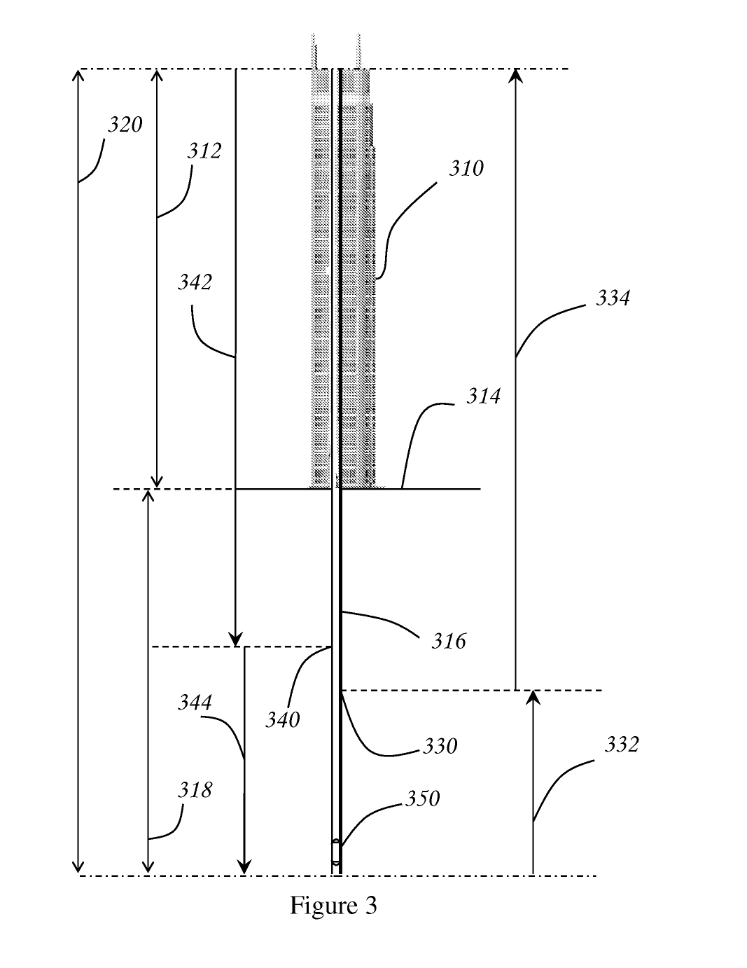

FIG. 3 shows an embodiment having the advantage of nearing a metro area as a tourist attraction. The illustrated embodiment shows a man-made structure 310 having a height 312 above ground level 314, and a well structure 316 having a depth of 318 under ground. The combination has a macroscopic vertical height 320. 330 is the injection point. 332 is the distance and direction for accelerating the vehicle 350. 334 is the distance and direction for free ascent by inertia of the vehicle 350. 340 is the recovery point. 342 is the distance and direction for free fall of the vehicle. 344 is the distance for braking and slowing down of the vehicle. Power is generated during the braking.

According to the basic principles of the invention, the vehicle's velocity at each point on the vehicle guide is computer-controlled by the computed velocity along the guide so that the desired gravitational acceleration, or G force, inside the vehicle 350 can be achieved. For clarity, the characteristics of a particular exemplary system will now be described in additional detail.

### Operations of the Embodiments

From the theoretical or mathematical point of view, this vertical zero G vehicle is a special case of today's zero G flights. That is to say, if the horizontal speed of today's zero G flight could be zero, it would be a vertical zero G machine. No difference is made whatsoever for the passengers. There is no instrument that can detect any difference between inside a zero G flight and inside a vertical zero G vehicle. However, from the operation and apparatus design point of view, they are totally different systems.

From the equations of the linear constant acceleration and deceleration motions, we have

V=g† Equation 1

h=½g†² Equation 2

V²=2gh Equation 3

Where V is the final velocity, after acceleration for a time period of t, starting from stationary
Note that V can also represent the initial velocity, then decelerating for a time period of t, to a stop
h is the distance traveled, that is the total height available
g is gravitational acceleration near the surface of the earth

For easy comprehension of the concepts, we use scientific or metric measurements and the approximation of 10 m/sec² for 9.81 m/sec² as the value of g, the gravitational acceleration near the surface of the Earth.

### Producing Weightlessness: A Basic Operation Mode

Using an example of a 3000-meter deep well structure in a mountain terrain as in FIG. 2A:

The vehicle is to be dropped controllably with the speed profile of a free fall from the top of the 3000 meters to the height of 1000 meters. This point is the recovery point. The distance traveled is 2000 meters. The time needed can be derived from Equation 2, which is t=20 seconds. This is the weightlessness time period inside the vehicle. The velocity will be 200 meters/sec at this recovery point from Equation 1. The numbers can be verified for consistency by Equation 3. There are 1000 meters left for bringing the vehicle to a stop. If the vehicle is to be decelerated with 2 g from this recovery point to the bottom, we get t=10 seconds from Equation 2. The needed distance is 1000 m from Equation 2 or 3. During this period, the passengers will experience 3G gravity because the Earth's gravity on top of the 2G deceleration of the vehicle. The human body can safely experience 3G′ s while lying flat on floor.

The vehicle is to be accelerated with 2 g from the bottom to 1000 meters. We called this point the injection point. The velocity will be 200 m/s upward at this injection point by using Equation 3. From this injection point on, the vehicle is to be decelerated controllably with the speed profile of a free ascent by inertia. Since the vehicle and any object inside it are decelerating at the same rate of g, the passengers will experience weightlessness during this time period, which is 20 seconds again from Equation 2. The vehicle and all its payloads will reach the top with zero speed from Equation 3. After reaching the top, the vehicle is to be dropped again controllably to accelerate downward with g. A total of continuous 40 seconds of weightlessness can be produced inside the vehicle this way. The process can be repeated or stops at the bottom to disembark thrill-seekers.

### Using the Building Height Plus Well Depth of Total 1200 Meters to Operate the Vehicle

The vehicle free falls from the top of the 1200 meters to the height of 400 meters, the recovery point. The distance traveled is 800 meters. The time needed can be derive from Equation 2, which is t=12.6 seconds. This is the weightless duration inside the vehicle. The velocity will be 126 meters/sec at this point from Equation 1. The data can be verified for consistency by Equation 3. There are 400 meters left for bringing the vehicle to a stop. If the vehicle is to be decelerated with 2 g from this point, we get t=6.3 seconds from Equation 2. The needed distance is 400 m from Equation 2 or 3. During this period, the passengers will experience 3G gravity because the Earth's gravity on top of the 2G deceleration of the vehicle.

The vehicle is to be accelerated with 2 g from the bottom to 400 meters, the injection point. The velocity will be 126 m/s upward at the injection point by using Equation 3. From this point, the vehicle is to decelerate freely. Since the vehicle and any object inside are decelerating at the same rate, the passengers will experience weightlessness during this time again for 12.6 seconds from Equation 2. The vehicle and all its payloads will reach the top with a speed of zero from Equation 3. After reaching the top, the vehicle is free falling again to accelerate downward with g. A total of continuous 25.2 seconds of weightlessness can be produced inside the vehicle. This process can be repeated. This method of making Zero G could have doubled the weightlessness time for the drop towers in our amusement parks today. The drop towers can not take advantage of this upward free ascent with inertia because the technologies were not ready yet. It requires a powerful and controllable catapult to shoot thrill-seekers up safely. Shooting payloads up using explosive or other means before the latest electromagnetic catapult are not practical.

### Operation Modes of Modulating Reduced Gravities:

To serve this purpose, the vehicle must “absorb” part of the gravitational acceleration g on the Earth's surface so that the “residual” acceleration can be used to modulate desired reduced gravities inside the vehicle.

### The Method of Modulating Gravity on the Moon is as Follows:

The gravitational acceleration ratio P on the surface of the Moon is ⅙ or 16% of the Earth. The vehicle system must absorb 1-P=⅚ of the Earth's gravitational acceleration g in order to produce ⅙ g inside the vehicle.

The vehicle accelerates with a high G from the bottom to a certain height, the injection point. After this point, the vehicle is controlled to ascend with the deceleration of (1-P)g. The inside of the vehicle will experience the Moon's gravity on the way up to the top.

From the top point, the vehicle is controlled to fall with an acceleration of (1-P)g to a certain point called recovery point. During this period, the interior of the vehicle will also experience the Moon's gravity.

After the recovery point, the vehicle is to brake or decelerate at a high G until stop at the bottom. The process can be repeated. The kinematics of the vehicle is again governed by the three equations of constant acceleration as listed above.

### The Method of Modulating Martian Gravity is as Follows:

The gravitational acceleration on the surface of Mars is 3.72 meters/sec², or the ratio P is approximately ⅜ to the Earth surface. The vehicle system must “consume” 1-P=⅝ of the Earth's gravitational acceleration g in order to produce ⅜ g inside the vehicle. That is to say the vehicle needs to be falling with 6.09 meters/sec² acceleration, or ascending with 6.09 meters/sec² deceleration.

### Description—Alternative Embodiment

Since the electric power needed to accelerate a zero G vehicle up with a high G is more than a public power grid system can deliver, an auxiliary private energy storage subsystem, e.g. batteries or capacitors etc., is needed for operating the basic embodiment described above. In a shipboard power generator system developed for Electro Magnetic Aircraft Launch Systems (EMALS), electrical power is stored kinetically in heavy rotors spinning at a high rpm. EMALS uses this energy storage subsystem to deliver a short pulse of high power to catapult Navy aircrafts to flight speeds. The energy storage subsystem needs forty to fifty seconds to restore its full power for the next launch. This cycle time would be too long for the present invention. In a hybrid automobile, electrical power generated by regenerative braking is stored in a battery, ready for driving the electrical motor. Similar designs of the energy storage systems would be too expensive and impractical for the present invention.

An alternative embodiment of the invention to solve the deficiencies of public power grid and energy storage subsystems is described as follows. The principle is using multiple vehicles and vehicle guides in a coordinated way. By scheduling and dispatching the vehicles such that while one vehicle is braking and slowing down, converting its kinetic energy into electric power like a generator, another vehicle is accelerating from the bottom and using the power being generated to accelerate up. With proper dispatch time interval of the vehicles, the operating power consumption and construction cost can be minimized because the need for an expensive energy storage subsystem like in the Navy's EMALS or batteries can be eliminated.

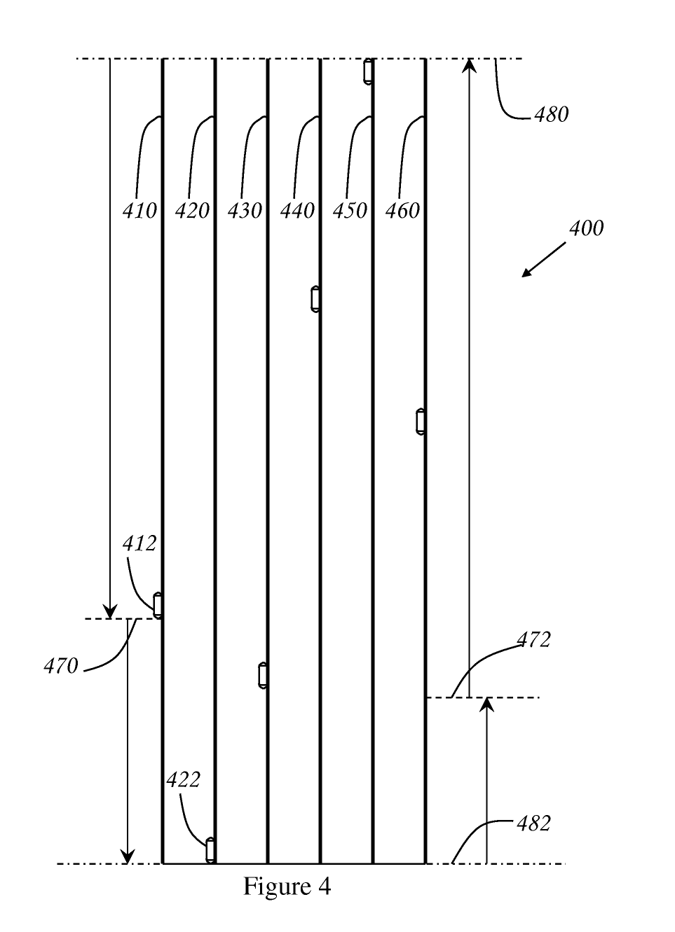

FIG. 4 shows a system 400 of multiple vehicle guides 410, 420, 430, 440, 450, 460 and vehicles 412, 422 etc. Each one vehicle guide with the vehicle is like the basic embodiment described before. The multiple sets of vehicle and vehicle guide are connected so that a single control and power distribution system is used. The system is to be operated in an orchestrated way such that one vehicle 412 reaches at the recovery point 470 and is generating power, another vehicle 422 starts from the bottom 482 and is consuming the power to accelerate up.

### Operation—Alternative Embodiment

An example of the scheduling of the vehicles of FIG. 4 is given as follows: Supposed a 24-second zero G system is to be designed, 12 seconds of zero G duration is from the upward free ascent, the other 12 seconds of zero G is from the free fall. A total of 24 seconds of continuous zero G is thus achieved. The height needed in this case is ½ g t²=720 meters using g=10 m/sec² t=12 seconds

Another 6 seconds is needed for slowing down the vehicle to 0 m/s at the bottom with a deceleration of 2 g. Six seconds is also needed for the acceleration up with an acceleration of 2 g or 20 meters/sec². The height needed is
½ 2 g t²=360 meters where t=6 seconds
The total height of the vehicle guide is 720+360=1,080 meters. In this basic design, both recovery point and injection point are at 360 meters above the bottom. A total of 12+12+6+6=36 seconds for each cycle, that is, 24 seconds of continuous zero G duration and 12 seconds of high G.

The time needed for the vehicle to slow down from the recovery point to the bottom is 6 seconds. The time needed for a vehicle to accelerate from the bottom to the injection point is also 6 seconds. The dispatch time interval will be therefore 6 seconds. Since each cycle is 36 seconds, a total of 6 vehicles and vehicle guides are needed for this particular system as in FIG. 4.

A simple starting configuration may have all vehicles located at the top 480 in FIG. 4 and dispatching one vehicle every six seconds. When vehicle 412 reaches the recovery point 470, it produces power back to the power grid. Six seconds later, vehicle 412 reaches the bottom and another vehicle will reach the recovery point. Vehicle 412 is accelerating up from the bottom using the power being generated by that vehicle. The same sequence applies to the rest of the vehicles. At the end of the ride, all vehicles need to return to the top.

A better starting configuration may have one vehicle at the bottom 482 and all other vehicles on the top 480. The scheduling will be as follows: The vehicles on the top are to be dispatched one by one at a predetermined time interval. That is six seconds in the cited example. When vehicle 412 reaches the recovery point, vehicle 422 at the bottom starts to accelerate up and is consuming the power being generated by vehicle 412. Six seconds later, vehicle 412 reaches the bottom and there will be another vehicle arrives at the recovery point. Vehicle 412 is using the power being generated by that vehicle. Vehicle 422 reaches the injection point 472 and starts it zero G ride for the next 24 seconds and so on. For the last cycle, five vehicles return to the top and stops there, only vehicle stops at the bottom. Each ride typically consists of thirty cycles, 36 seconds for each cycle, so that a total of eighteen minutes for each ride in this particular example.

This multiple-and-one starting configuration has the advantage of being a self-contained system. No surge power is needed from outside power sources. If a separate energy storage subsystem is to be eliminated in order to save design and construction costs, this multiple-and-1 configuration will be a preferable embodiment.

### Description—Alternative Embodiment

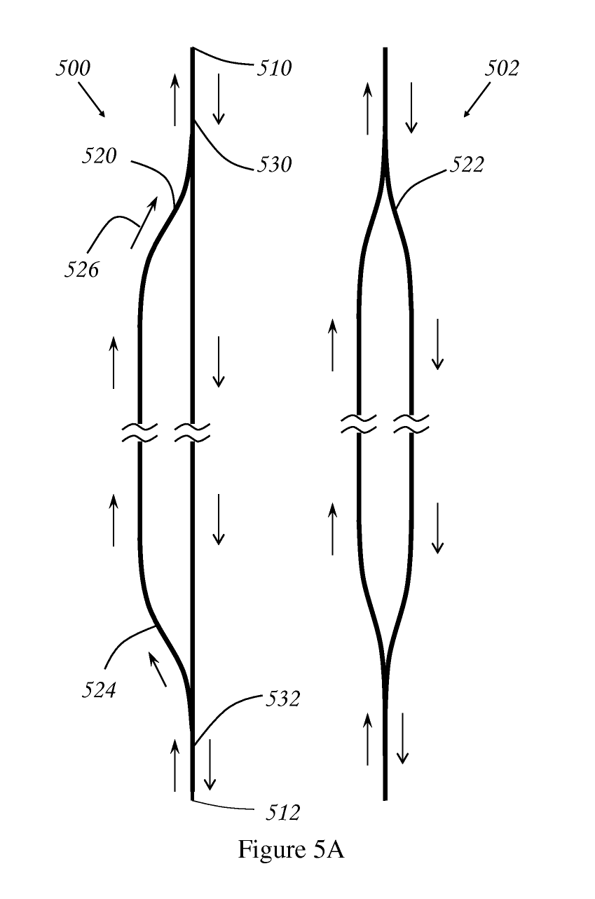

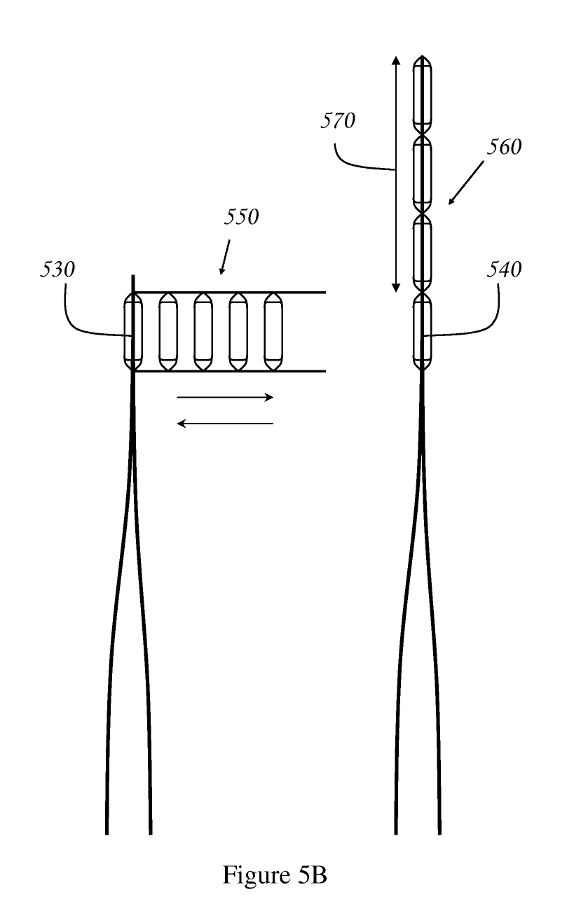

FIG. 5A shows two possible shapes 500, 502 of a vehicle guide loop. The guide loop is used for multiple vehicles for the purpose of modulating zero and variable gravities. The loops are composed of two parallel vehicle guides merged at the top portion 530 and bottom portion 532 with smooth curves 520, 522, 524 etc. There will be a horizontal acceleration experienced inside vehicle cabins while vehicles are moving along the curves. This effect will be minimal because the speeds near the top and bottom portions of the vehicle guide loop will be approaching zero.

Multiple vehicles moving in one direction only (clockwise or counterclockwise) allows multiple vehicles sharing the same vehicle guide loop and avoid collision. In FIG. 5A, the arrows 526 along the loops indicate the direction of the movement of the vehicles. One cycle of a vehicle's travel involves the vehicle moving up and slowing down on one side of the parallel guide tracks to the top, stopping momentarily at the top portion 530 of the guide track, and then moves down to the other side of the guide loop. The same movement is required near the bottom of the guide loop. A vehicle is slowing down on one side of the parallel guide track to the bottom, stops momentarily at the bottom portion 532 of the guide track and then moves/accelerates up to the other side. Thus multiple vehicles can be dispatched at a fixed time interval and operated on the vehicle guide loop simultaneously. Operating multiple vehicles on one vehicle guide loop track can optimize the usage of the vehicle guide track and minimize the space and construction costs.

FIG. 5B shows two types of parking mechanisms 550 and 560 for a guide loop in FIG. 5A. Mechanism 550 moves the vehicles horizontally from the vehicle guide track to a parking position for embarking and disembarking. Mechanism 560 moves the vehicles up to the extended guide track 570. These parking mechanisms should be located at the top portion 530 where the speed of the vehicle will be zero. In a multiple-and-one starting configuration described, no such parking mechanism is needed at the bottom portion 532 since only one vehicle is at the bottom.

### Control of the System:

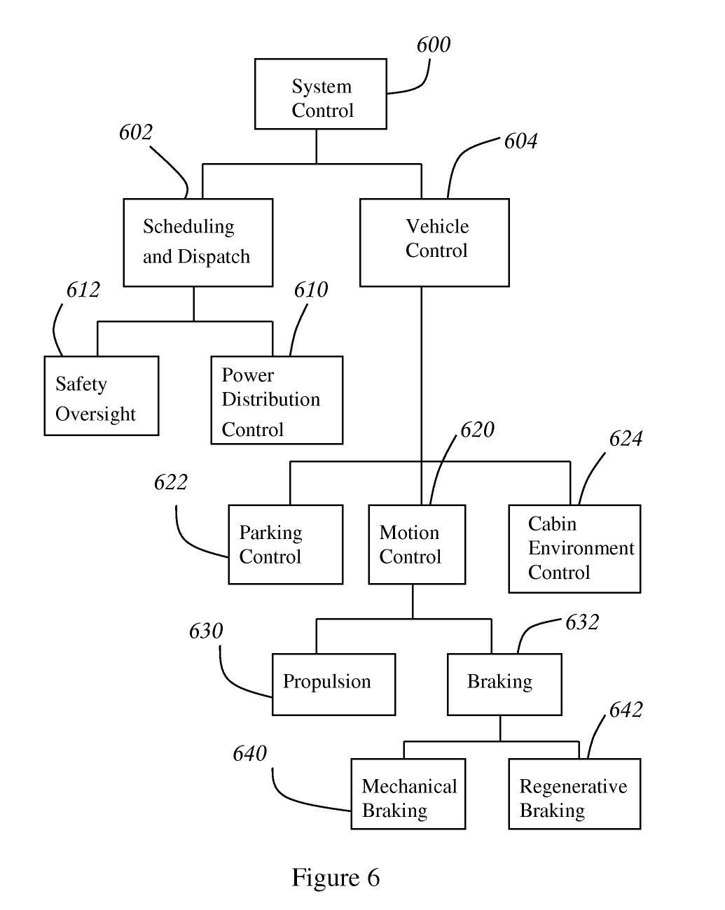

As illustrated in FIG. 6, the system control 600 includes a scheduling/dispatch subsystem 602 and a vehicle control subsystem 604. The scheduling and dispatch subsystem also includes a power distribution subsystem 610. The scheduling and dispatch subsystem 602 receives operator input and calculates appropriate system responses including, for example, scheduling and controlling departure times. The illustrated safety oversight subsystem 612 serves to report on system conditions and to automatically ensure that system constraints governing safe operational speeds and inter-vehicular distances are maintained.

The system can be programmed to perform several operation modes as discussed above. That is modulating zero gravity, Martian gravity, Moon gravity, and launching vehicles etc. The vehicle control subsystem 604 controls the attributes and operation of a particular vehicle according to a specific operation mode. For example, the vehicle control subsystem includes and controls a motion control subsystem 620 that, in turn, includes and controls a propulsion system 630 and a braking system 632 to execute a predetermined velocity profile of the vehicles. The propulsion system 630 includes, in various embodiments, a system for the control of electric motors, linear electromagnetic motors, and any other appropriate driving devices. The braking system 632 includes, in various embodiments, a system for the control of friction brakes 640, dynamic regenerative braking 642, and any other appropriate braking device. In various embodiments and operation modes, the control system includes computer processors, memories, interface equipment, storage devices, digital to analog converters, amplifiers and motors. In various embodiments and operation modes of the invention, the control system includes software and firmware adapted to control an operation of such computer processors and the described ancillary equipment.

As illustrated, the vehicle control system 604 also includes and controls a vehicle parking control 622 and a vehicle cabin environment control 624. The parking control is to move the vehicles in a specified space for embarking and disembarking as illustrated in FIG. 5B. Vehicle cabin environment control 624 is to regulate the pressure and climate control inside cabin.

### Human Occupants:

According to certain principle of the invention as mentioned previously, the injection point and recovery point are programmable. The locations of these points along the vehicle guide are depending on the intended operation. This is also to insure the safety and comfort level of the passengers. Human body's tolerance of high gravitational force and the rate of change of the G forces must be considered as in USPTO Pub. App. No. 20080078875 title: Method for Reducing Motion Sickness during Parabolic Flight. Five G is about the comfort limit of an untrained person. A sudden transition from a high G to a zero G state is an exciting sensation and it is safe. However, a sudden change from zero G to a high G force may cause injury.

In the preceding examples of the basic embodiments, we have both the injection point and the recovery point located at the same height above the bottom. In fact, the positions of these points should be also adjusted according to human factors. By taking into account the human body's tolerance of the change of G forces, the recovery points 220, 340 and 470 should be higher than the injection points 210, 330 and 472 in order to have time for a gradual transition from zero G to high G′s. The results are indicated in FIG. 2A, FIG. 3 and FIG. 4. Human body can cope with a sudden change from a high G to zero G without any safety concern, and it is an exciting experience for the thrill-seekers. However, changing from a zero G to a high G at the recovery point must be gradual to avoid injuries. Muscles and bone structures need time to adjust to the increase of forces applied to the body. Studies have shown that this forced exercise is an excellent way of preventing and reducing obesity. This leads to the need of applying the definition of the rate of change of acceleration, or jerk, represented by j, and used to describe a changing acceleration and force.

$${j}^{->} = \frac{d {a}^{->}}{d t} = \frac{{d}^{2} {v}^{->}}{d {t}^{2}} = \frac{{d}^{3} {s}^{->}}{d {t}^{3}}$$

Where a is acceleration, v is velocity, and s is distance. The unit of change of acceleration, jerk, is m/sec³. Since the force is directly proportional to the acceleration, jerk also means the rate of change of forces. A jerk of a half g per second, or 5 meters/sec³ or less, can be considered safe.

We used a constant deceleration of 2 g, or 20 meters/sec², for the slowing down from the recovery point to stop at the bottom in the basic design example above. For a safer operation, the recovery point needs to be higher than the injection point for an extra time needed to transition gradually from zero G to higher G′s as indicated in the diagrams.

We used a constant acceleration of 2 g, or 20 meters/sec², to accelerate from the bottom up to the injection point in the basic examples. Since it is safe for human body to experience a sudden change from high G to zero G, an alternative embodiment using an increasing acceleration, or a constant jerk, can lower the injection point and increase the zero G duration.

### Conclusion, Suppliers, and Scope

Before the advent of a practical linear electromagnetic motor, the power of catapults is delivered by steam, hydraulic, chemical or mechanical means. There is no control of the acceleration once they are triggered. The payloads are suffering from unpredictable huge stresses. They are not suitable for human occupants or other delicate payloads, not for use inside a building or confined spaces either. EMALS (Electro-Magnetic Aircraft Launch System) uses electromagnetic power, an approach similar to a rail gun. This approach provides a controllable launch suitable for the disclosed gravity modulation vehicle application. Supplier information is provided by various patents and other publications. For examples, U.S. Pat. No. 7,830,047 and General Atomics Electromagnetics Project Overview. It is well-known in the industry that General Atomics, Northrop Grumman and several other defense contract companies have successfully demonstrated the related technologies. The Navy had launched the first aircraft, an F/A-18E Super Hornet, by EMALS in December, 2010. This description discloses a modified version of the same technology for achieving the purpose of the invention.

Accordingly the reader will see that while the above description contains details and specific examples, these should not be construed as limitations on the scope of any embodiment, but as exemplifications of various embodiments thereof. Many other ramifications and variations are possible within the teachings of the various embodiments. Thus the scope should be determined by the appended claims and their legal equivalents, and not by the examples given.

1. A system for modulating selected gravity environments and launching vehicles, comprising:
a vehicle or a plurality of vehicles having cabin spaces wherein
payloads can be accommodated in said cabin spaces; and
a substantially vertical vehicle guide or a plurality of substantially vertical vehicle guides including means for driving and braking said vehicles; said vehicle guides movably support and control said vehicles to accelerate and decelerate said vehicles such that said selected gravity environments will be experienced inside said cabin spaces for a substantially long period of time.

2. The system as defined in claim 1, wherein said vehicle guides are supported by the structural integrity of an underground well in a beneficially chosen terrain feature and location for a macroscopic height of said vehicle guides.

3. The system as defined in claim 2, wherein said macroscopic height is at least 300 meters.

4. The system as defined in claim 1, wherein said vehicle guides are supported by the structural integrity of a building for an additional macroscopic height of said vehicle guides.

5. The system as defined in claim 4, wherein said additional macroscopic height is at least 300 meters.

6. The system as defined in claim 1, wherein said substantially long period of time of said selected gravity environments is at least fifteen seconds.

7. The system as defined in claim 1, wherein said vehicle is releasably attached to said vehicle guide.

8. The system as defined in claim 1, wherein said means for driving and braking said vehicles are electromagnetic devices.

9. The system as defined in claim 1, wherein said vehicle guide is used for modulating said gravity environments by accelerating said vehicles to a predetermined point and decelerating said vehicles to another predetermined point along said vehicle guides.

10. The system as defined in claim 1 wherein said payload is adapted to produce a process result related to said modulated gravity environments.

11. The system as defined in claim 1, wherein said payload includes human occupants and said modulated gravity environments include an entertainment experience and fitness exercise.

12. The system as defined in claim 1, wherein said plurality of vehicle guide includes a pair of substantially parallel vehicle guides, wherein the lower portions and upper portions of said parallel vehicle guides are merged into extended sections to form a guide loop.

13. A method of modulating selected gravity environments and launching vehicles, comprising:
identifying a beneficial macroscopic height for deploying a substantially vertical vehicle guide or a plurality of substantially vertical vehicle guides;
accommodating payloads in a vehicle or a plurality of vehicles attached to said vehicle guides;
accelerating and decelerating said vehicles along said vehicle guides so as to subject said payload to said selected gravity environments.

14. A method according to claim 13, wherein said vehicles accelerate and decelerate along said vehicle guides so as to subject said payload to said modulated gravity environments comprises subjecting said payload to a substantially zero gravity.

15. A method according to claim 13, wherein accelerating and decelerating said vehicles further comprises controlling said vehicles with a computerized control according to a predetermined velocity profile along said vehicle guides.

16. A method according to claim 15, wherein said vehicle guide accelerates said vehicle from the lower portion to the top of said vehicle guide and release said vehicle.

17. A method according to claim 15 wherein said vehicle guide accelerates said vehicle from the lower portion of said vehicle guide up to a predetermined point on said vehicle guide and decelerates said vehicle according to a predetermined velocity profile to the upper portion of said vehicle guide.

18. A method according to claim 15, wherein said predetermined velocity profiles along said vehicle guides are determined by said selected gravity environments and payloads.

19. A method according to claim 13, wherein said vehicles are scheduled and dispatched on said vehicle guides such that while one vehicle is braking, another vehicle is accelerating upwards.
